(19) United States
(12) Patent Application Publication
(10) Pub. No.: US 2012/0080884 A1
(43) Pub. Date: Apr. 5, 2012

(54) CORNER WIND TURBINE FOR TALL BUILDING

(75) Inventor: Francois Gagnon, Montreal (CA)

(73) Assignee: Mr. Francois Gagnon, Montreal (CA)

(21) Appl. No.: 13/245,992

(22) Filed: Sep. 27, 2011

Related U.S. Application Data
(60) Provisional application No. 61/387,603, filed on Sep. 29, 2010.

(51) Int. Cl. F03D 9/00

(52) U.S. Cl. 290/55

(57) ABSTRACT

The present invention is base on aerodynamic flows and turbulences that surround tall building under various wind conditions. When buildings are relatively tall, there is more airflow surrounding their walls than over it.

When the wind reach in angle a surface of a building, this wind will generally slide on this face to the end of it. As all the wind that come to that surface will run to the same ending point, there will be an important concentration of wind at this point. On the other hand, the following wall will receive no wind and will be under low pressure. This is a perfect location for wind turbine, and the first object of our invention.

### FIELD OF THE INVENTION

The present invention is relates to the production of electricity by the integration of wind turbines in the structure of large building. Some of the propose embodiments may be install on existing building, the most efficient one will be integrated in new construction.

### BACKGROUND OF THE INVENTION

The Installation of wind turbine on building is not a new concept. Building reduce mass and foundation requirement to expose the apparatus to the wind and should be widely used. Since a decade the demand for green and renewable energy have pushed inventors to propose new wind turbines to be install on building, but no technology had produce significative impact on market as most proposal suffer of problems that damper their use. Most of the past proposals are noisy or awkward and they induce stress and vibration on building with wind gust. Some other are simply not efficient enough to justify the investment. For example, many proposals disclose static apparatus that work only when wind directly face the according walls of the building, producing electricity only few days per year.

We disclose in international patent pending CA2010001480 (further PP80) some innovations for wind turbines that can be effective if use on top of building. We will use some of those disclose techniques in the realisation of the present inventions.

### SUMMARY OF THE INVENTION

The present invention is base on aerodynamic flows and turbulences that surround tall building under various wind conditions. We have already disclosed apparatus that will harness wind from the top of buildings, but when those are relatively tall, there is more airflow surrounding their walls than over it.

When the wind reach in angle a surface of a building, this wind will generally slide on this face to the end of it. As all the wind that come to that surface will run to the same ending point, there will be an important concentration of wind at this point. On the other hand, the following wall will receive no wind and will be under low pressure. This is a perfect location for wind turbine, and the first object of our invention.

The present invention possesses numerous benefits and advantages.

First the surface of wind that is harness is as large as the building itself. The maximum surface harness is the length of the longest diagonal by the high of the building. The working surface will vary with wind angle and will generally be a little less. For example a building of 45 stairs with a frontage of 50 meters will harness a surface of wind from two to three time larger than a two megawatts giant wind turbine.

As the wind will be concentrate from a large surface, the network of wind turbine will produce electricity with wind as low as 4 or 5 Km/h. On the other hand, the pales of the turbine will be relatively small and there will be no need to break down the rotation speed, which will allow efficient harnessing of high-speed wind.

The electricity will be use on site. This mean a better efficiency as there will be no lost in the grid.

The most efficient apparatus will be install on new building project, but our corner wind turbines may also be install on existing building.

Most installation projects will be easy to finance, as profitability will be base on electricity at retail cost. With forthcoming energy price that will increase much faster than inflation, most owner will be ready to invest up to 20 times the value of their annual reduction in energy cost.

### BRIEF DESCRIPTION OF THE DRAWINGS

In the appended drawings:

FIG. 1 is an overall view of the airflow around a square building.

FIG. 2 show details of the airflow at the end of a surface of a building that face wind.

FIG. 3 is a top view of an apparatus that can be install on existing building. The figure shows the flow of the wind.

FIG. 4 is the same view with dimensions and references.

FIG. 5 is a top view of a more efficient apparatus that is design to be install on new building.

FIG. 6 is a top view of an adaptive apparatus that will harness wind more efficiently.

FIG. 7 shows the same apparatus in regular wind position.

FIG. 8 show the same wind turbine in high wind position.

FIG. 9 show the same apparatus in low wind position,

FIG. 10 show the same wind turbine in security position to face hurricane.

FIG. 11 show a more efficient embodiment of the adaptive wind turbine that can be install on a new building.

FIG. 12 is a scale drawing that compare the harnessing potential of a large building beside a two Mwatts wind turbine.

### DESCRIPTION OF EMBODIMENTS OF THE INVENTION

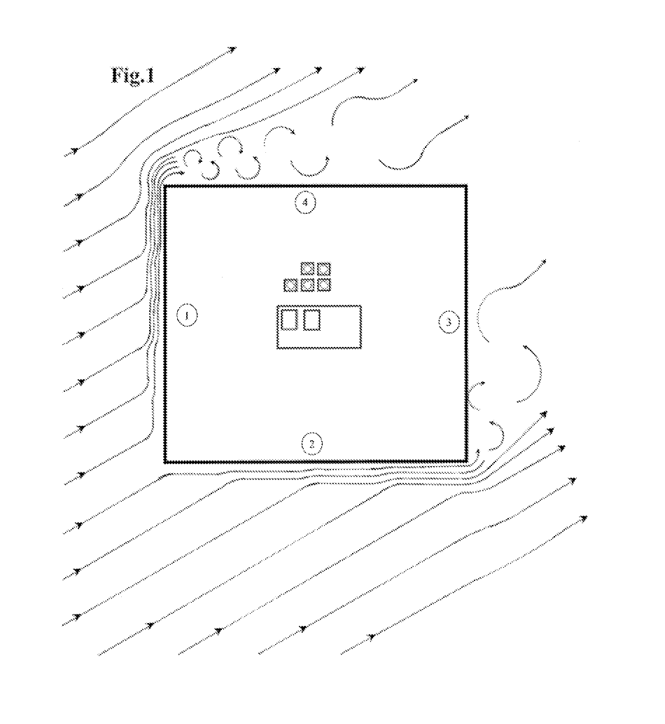

FIG. 1 illustrates the airflow dynamic around a square building. The wind can come to the building from any direction and with all its usual speed range. In this example the wind come to the surface 1 of the building with an angle of 60 degrees, and hit the surface 2 with an angle of 30 degrees. The various angle of incoming wind will produce different mix of compress wind at the end of expose surface, sometime with higher pressure, sometime with higher speed, but always with a speed vector parallel to the wall.

The FIG. 1 also shows that opposite wall 3 and 4 has a very different wind and air pressure structure. The wind that exits the deflective walls 1 and 2 will rapidly try to reach its initial position and vector, inducing low pressure and wind turbulence on walls 3 and 4. The use of low pressure to ease the exit of outgoing airflow from wind turbine is already well detail on existing technique.

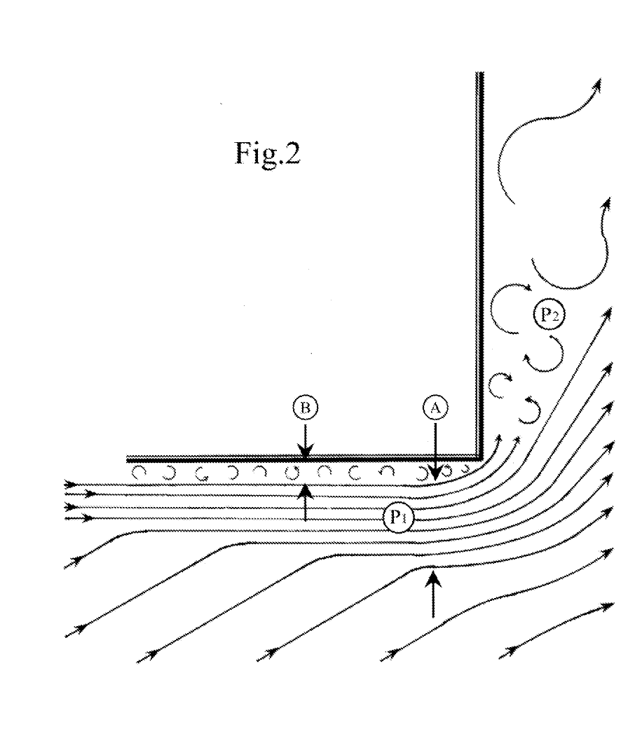

The FIG. 2 shows some details of airflow at the corner of two walls where one wall faces the wind, but not the second one. We can see that the deflected wind will end at the corner of the building with a width of A. The length of A, the speed of the wind at this point and the pressure of the airflow will vary with the incoming wind vector and the length of the wall. We can also see that there will be a turbulence of width B on the deflecting wall. This turbulence will vary with incoming wind vector, but also with the ‘texture’ of the surface of the wall. With smooth wall, the length B will be small and stable, which will ease the harnessing of the wind flow in A. Many wall will have small obstacles of few inches that will not increase to much the length B, but large obstacle, like balcony on residential building, will produce large and variable turbulence that will damper the capability to harness the wind in A.

The FIG. 2 also shows that the maximum pressure P₁ and the minimum pressure P₂ will be very close and can be used by a corner wind turbine.

As the interest for installation of wind turbine at the corner of building is now establish, we need to list the most important design criteria:

First, a corner wind turbine must be install on the entire height of the building. As wind will vary from the bottom to the top of the building, the corner wind turbine will have to be divided in a network of smaller turbines in order to harness the wind at its maximum efficiency.

Second, the apparatus must be of architectural quality, meaning that it will have to stand secure and operational for the expected live time of the building.

Third, the wind turbine will not induce any noise or vibration to the building.

Fourth, the wind turbine must be fully integrate to the building architecture, meaning that it must be esthetic, not awkward visually and produce no noise at ground level.

Fifth, some embodiment must be available for existing building, meaning that it may be install over existing structure without adding significative weight or shear stress to the existing structure. These include potential shear stress from hurricane.

Sixth, the wind turbine must be fully reversible to harness wind from any direction with equal efficiency.

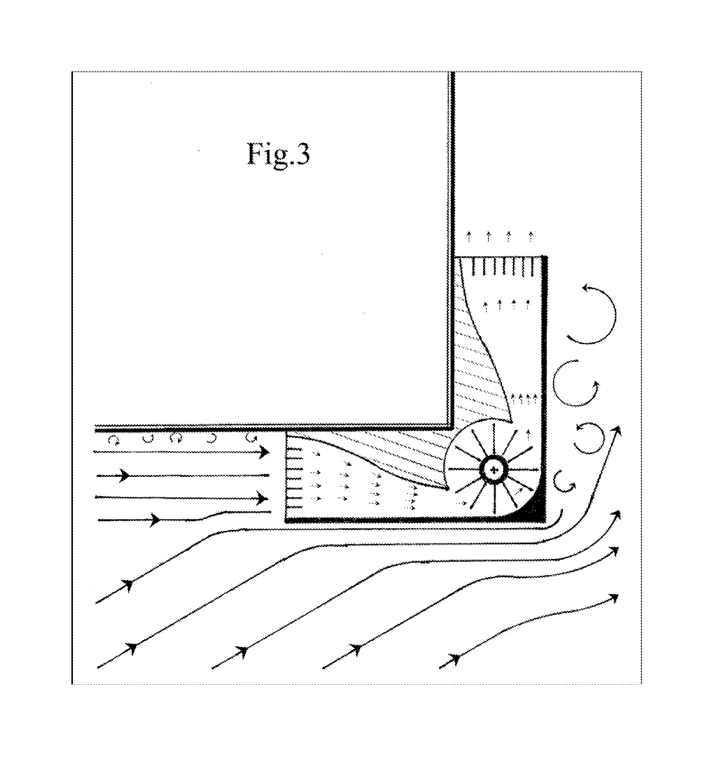

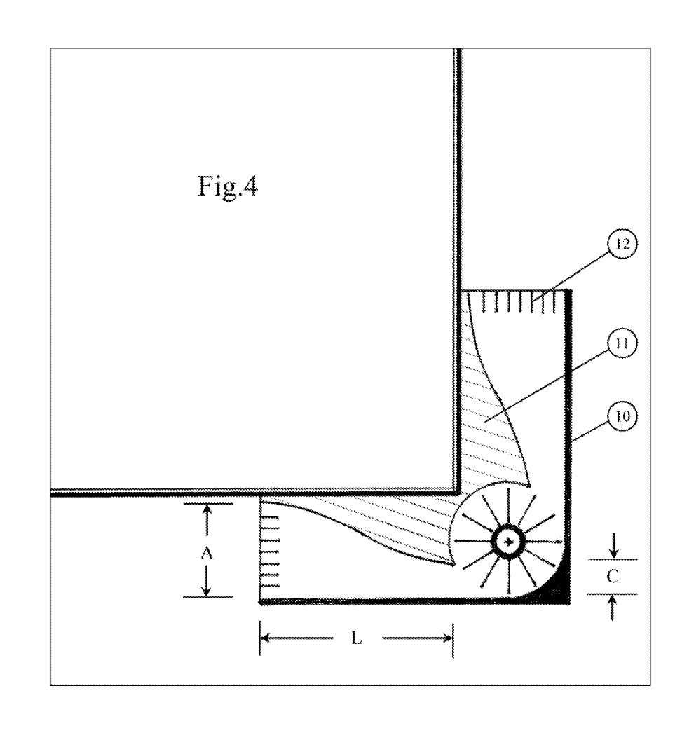

FIGS. 3 and 4 show an apparatus that can harness wind form the corner of an existing building. We can see first that the apparatus is totally symmetric and that it can harness wind from both side. The wind enters the turbine by the opening A that is as close as possible as the expected wind flow A previously discuss in FIG. 2. The wind is compress to the width C along the distance L. The compression ratio NC must be keep as low as possible as the incoming wind is already compress, and the distance L must be as long as possible to keep the compression of the air flow in laminar fashion (see PP80).

Still referring to FIGS. 3 and 4, we can see that turbine pales are straight. This design make the turbine reversible and, as disclose in PP80, it is more efficient for an enclose apparatus. Other canalizations and turbines design, similar to those disclose in PP80, can also be used with the corner wind turbine.

Still referring to FIG. 4, the channel structure 11 is done with materials that have good noise and vibration absorption characteristic, like expanded polystyrene or recycle rubber. The two input/output opening are protected with aerodynamic lath 12 that reduce noise and protect large bird from the turbine. The outside structure 10 is made of strong material that can support glass or other decoration that will enhance the architectural design of the building.

Still referring to FIGS. 3 and 4, we can see that the input and the output area are the same. This will significatively reduce the efficiency of the apparatus to transform wind energy in electricity, as disclose in PP80. This problem is enhancing by the fact that the direct output of the turbine is of the same size of the direct input. This problem has a partial solution. The output wall will always be at a much lower pressure than the input one; this will help to exhaust the outgoing wind, but this alone will not fully compensate the aerodynamic restriction.

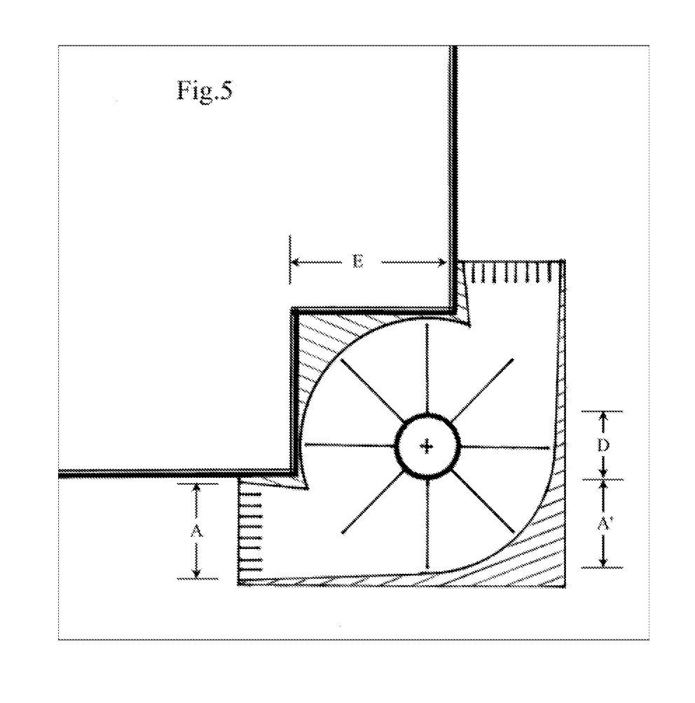

The FIG. 5 show a more efficient version of the corner wind turbine show in FIGS. 3 and 4. This apparatus could only be use in new construction as it is need to step inside of the building. Here we have no compression ratio of the incoming wind as the input A is similar to the pale length A′. The exhaust of the outgoing wind will also be easier as output channel is larger, but still not larger that the input one. Increasing the size of the center of the turbine D may also increase the efficiency, but its also use more space inside the building as the length E will approximately be D+A′. Both turbine design of FIGS. 4 and 5 will be very quiet and a good choice for the lower stair of a building, up to the fifth or eight floor.

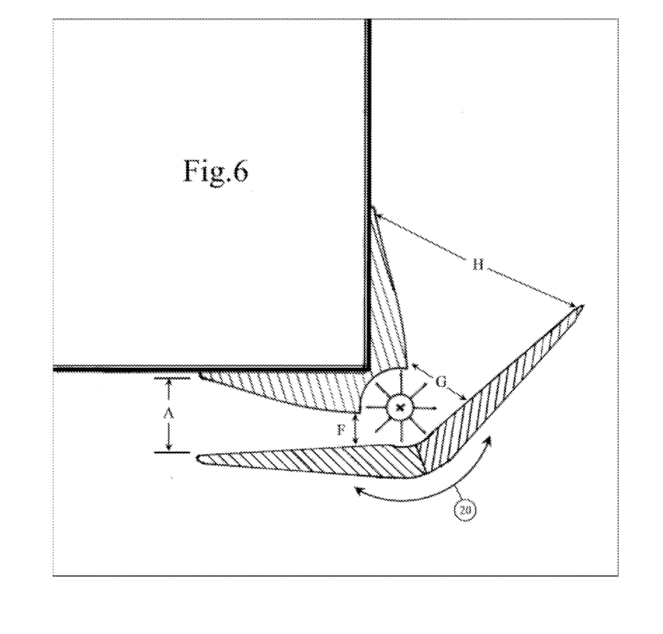

The FIG. 6 shows a more efficient apparatus for a corner wind turbine. Here the outside structure is mobile and can rotate in 20, this movement is center with the axis of the turbine.

Still on FIG. 6 we have now an intake opening where A is variable in size. We also have a direct intake F of turbine that will also vary in size, thus the compression ratio A/F will have a large range of possible value. We will also have an improve efficiency as the direct output size G is significatively larger than input F. This improvement will be enhance with the final output size H that will be significatively larger than input A, for a maximum use of the output surrounding pressure that is still much lower than the input one.

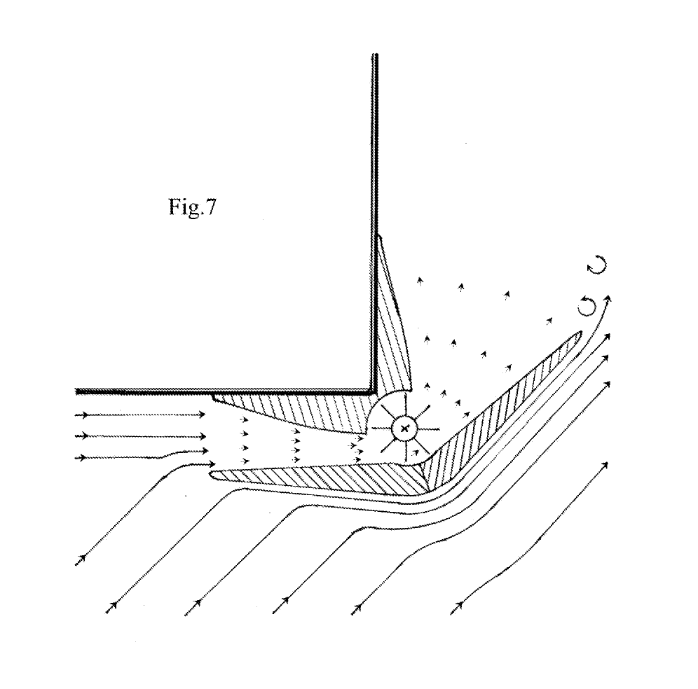

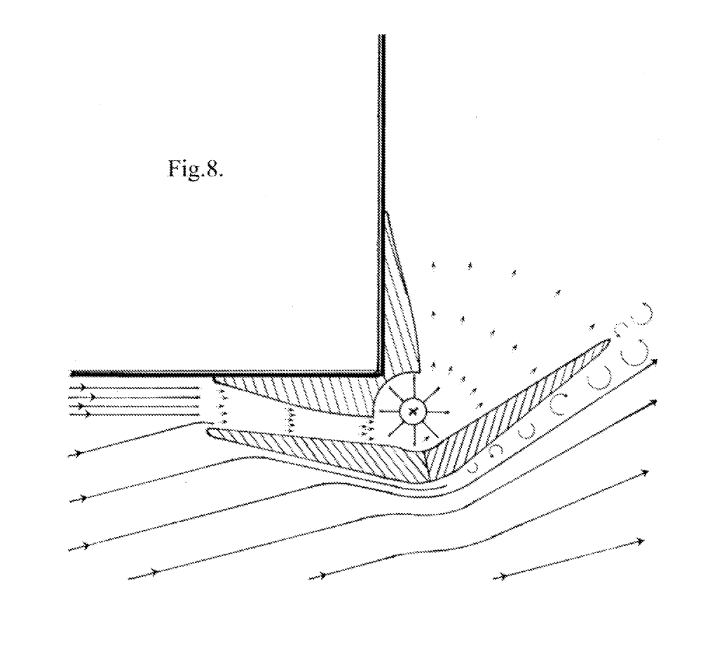

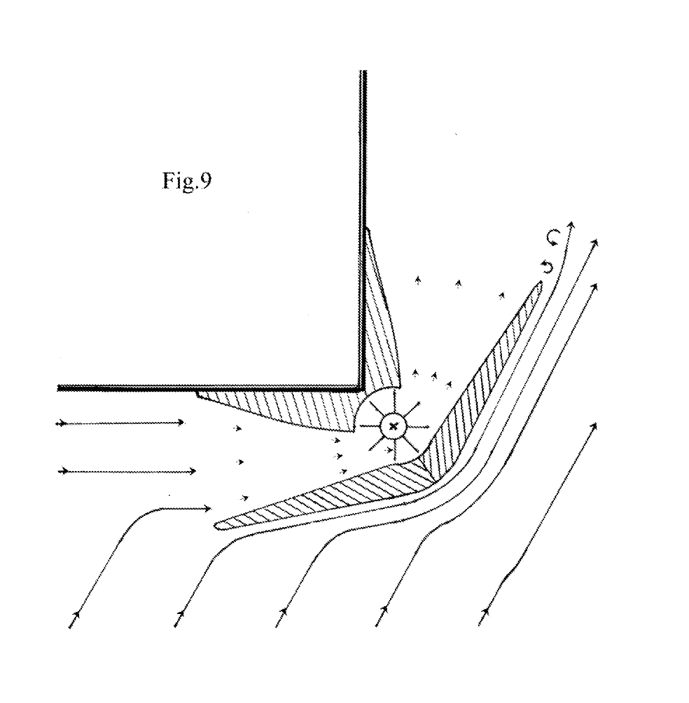

Now referring to FIGS. 7, 8 and 9, we have different working position of our adaptable corner wind turbine. On FIG. 7, the position of outside panel give an A measurement that is according to the basic A dimension of average airflow concentration from FIG. 2. Here the concentration ratio A/F is 2, which is good for average wind, the direct input/output ratio G/F is also 2, which will not generate any restriction, and the general input/output ratio H/A is 3, which will allow the maximum use of the low pressure to ease the exit of the wind. On FIG. 8, the apparatus have a smaller intake A that will be profitable for high wind. The compression ratio A/F will be around 1.5 and the exhaust ratios are even larger. On FIG. 9 we have a very low wind configuration; at this point we have a double size opening that will harness a maximum quantity of wind with a compression ratio of 3, here the exhausting ratios are still acceptable.

The blend of incoming wind to the corner wind turbine will be extremely various, as it will depend both on speed and direction of the original airflow. The positioning of the outside panel will thus be control by a computer. As disclose for the wind deflector of PP80, the computer will record the power output of every turbine. As one turbine will be slightly more open, and another one more close, the software will determine the most efficient opening angle to harness wind and realign the entire network to this position, this in a continuous process.

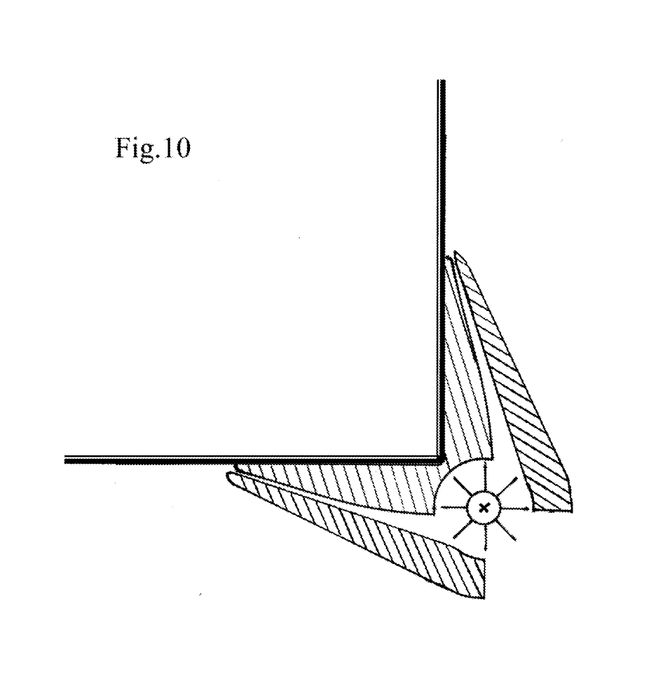

The FIG. 10 shows the same apparatus in safe position to face a hurricane. This drawing show that the moving panel is made of two parts that can be split when require.

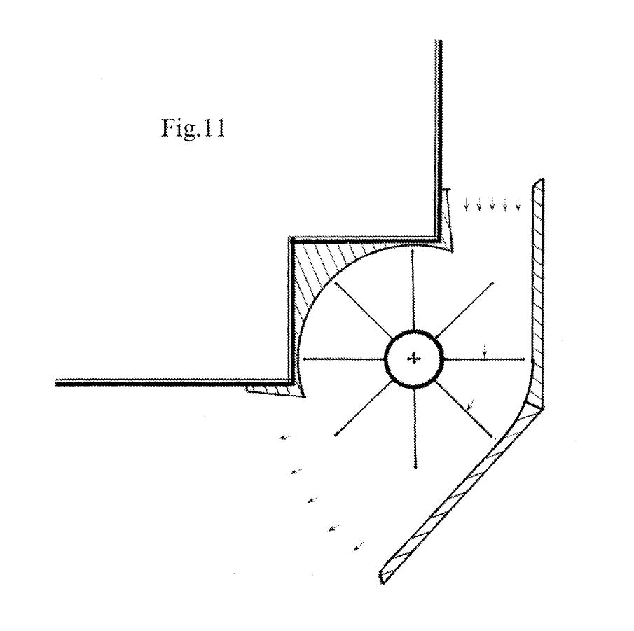

The FIG. 11 show a more efficient apparatus that can be install on new building only, as it's require that a part of the turbine was enclose in the building. As per apparatus of FIG. 5, the main advantage of this configuration is that there will be no compression of the incoming wind.

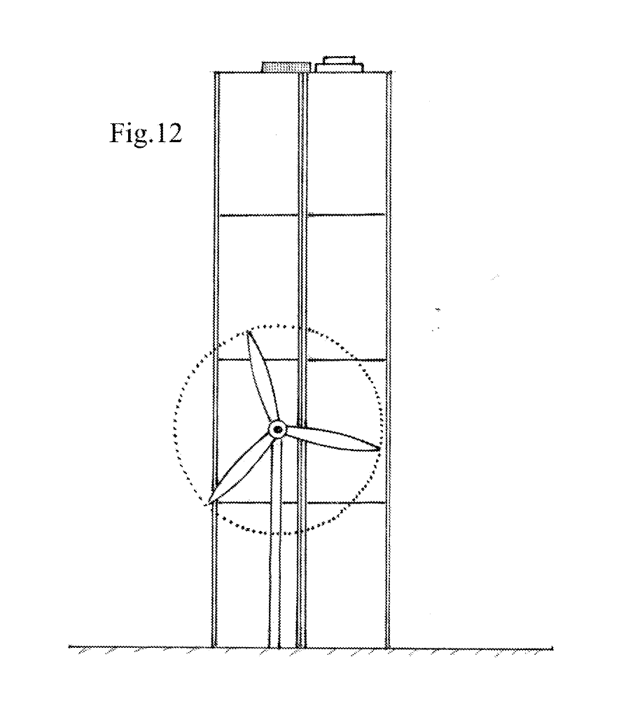

The FIG. 12 shows a scale representation of a building of 47 stairs beside a 2 Mwatts tri-blades wind turbine. The tri-blades will harness 4,000 square meters of wind, while the building will face 8 to 11,000 sq.m. of it. The tri-blades will start to produce electricity with incoming wind of 10-12 Km/h. The building will concentrate the air stream in a way that a 4-6 Km/h incoming wind will begin some production of power. Half of the wind catch by the building will be at a higher distance from ground then the tri-blades. There will be a lot of lost in turbulence and overflow when using a building as a wind concentrator for corner wind turbine, and we do not expect to produce the same energy per sq.m. as the tri-blades, but overall year production of energy of our 47 stairs building should be comparable to the 2 Mwatts tri-blades apparatus.

1. A relatively rectangle building with relatively flat outside walls can be use to concentrate wind onto wind turbine apparatus place at each corners of those outside walls of the said building.

2. The corner wind turbines of claim 1 are fully reversible apparatus that can harness wind from one or the other adjacent wall of the host building to produce electricity or useful mechanical power.

3. The mechanical and moving part of the turbine of claim 1 are enclose or embedded in material with good absorption characteristic for vibration. This embodiment is design to protect host building from noise and vibration.

4. The corner wind turbine for building of claim 1 is made with solid-state structure that could support architectural surface finishing and stand for the expected live time of the building.

5. The corner wind turbine of claim 1 will be install from bottom to top of each corner of host building of claim 1. As wind speed vary with height and in order to harness the said wind more efficiently, the corner wind turbine of claim 1 will include a plurality of smaller wind turbine assemble in network.

6. The height of each of the smaller wind turbine of the claim 5 will be similar to the height of the stair of the host building. This height will be adapted to ease a strong fixation of the corner wind turbine of claim 1 to the host building.

7. The corner wind turbine of claim 1 can have a fix structure that is design to produce no significative noise and no visible movement around the host building.

8. The corner wind turbine of claim 1 can have an adaptive structure that can improve the harnessing of wind to produce electricity or useful mechanical power.

9. The adaptive corner wind turbine of claim 8 will be manage by an heuristic computer software. This software will continuously change the configuration of some smaller turbine of claim 5 and compute the resulting power. After calculation, the software will change the configuration of each smaller turbine of claim 5 to the optimal configuration.

10. The adaptive corner wind turbine of claim 8 comprising a safe position to face hurricane.
